(19) United States
(12) Patent Application Publication
(10) Pub. No.: US 2004/0213367 A1
(43) Pub. Date: Oct. 28, 2004

(54) Synchronizing satellite clock in base transceiver station

(76) Inventor: Choel-Hee Han, Seoul (KR)

Correspondence Address: Robert E. Bushnell, Suite 300, 1522 K Street, N.W., Washington, DC, 20005, US

(21) Appl. No.: 10/823,733

(22) Filed: Apr. 14, 2004

(30) Foreign Application Priority Data
Apr. 25, 2003 (KR) 2003-26506

(51) Int. Cl. H04L 7/00

(52) U.S. Cl. 375/354

(57) ABSTRACT

A system for synchronizing clocks includes: a GPS receiver module adapted to extract clock information and TOD information from a received GPS signal, to generate and output a clock signal and TOD data to a first base transceiver station and a base transceiver station of a next stage, the GPS receiver module being arranged within the first base-station transceiver; and a clock module adapted to generate a clock signal and TOD data synchronized with the clock signal and the TOD data of the first base transceiver station by performing a delay correction with one of the GPS receiver module of the first base transceiver station or a base transceiver station of a previous stage, and to output the clock signal and the TOD data to its base transceiver station and a base transceiver station of a next stage, upon the clock module receiving a clock signal and TOD data from one of the GPS receiver module of the first base transceiver station or the base transceiver station of the previous stage through a daisy chain, the clock module being arranged within a base transceiver station other than the first base-station transceiver.

### CLAIM OF PRIORITY

This application makes reference to, incorporates the same herein, and claims all benefits accruing under 35 U.S.C. § 119 from an application entitled SYSTEM FOR SYNCHRONIZING SATELLITE CLOCK IN BASE TRANSCEIVER STATION AND METHOD THERE FOR earlier filed in the Korean Intellectual Property Office on 25 Apr. 2003 and thereby duly assigned Serial No.2003-26506.

### BACKGROUND OF THE INVENTION

1. Field of the Invention

The present invention relates to synchronizing a satellite clock in a base transceiver station. More particularly, the present invention relates to synchronizing the satellite clock in base transceiver station wherein clocks of base transceiver stations are synchronized by efficiently distributing global positioning system (GPS) information to each base transceiver station in a wireless private exchange system in an office environment.

2. Description of the Related Art

When a GPS is used in a wireless private exchange system in an office environment, each customer base transceiver station has to be directly connected to a GPS antenna in a one-to-one manner or each customer base transceiver station has to be connected to a distributor distributing the GPS signal from one GPS antenna to each customer base transceiver in a one-to-many manner.

Accordingly, if the customer base transceiver station and the GPS antenna are directly connected in the one-to-one manner, each customer base transceiver has to have a GPS antenna and a global positioning system receiver (referred to as a GPS receiver module, hereinafter).

On the other hand, if each customer base transceiver station has to be directly connected to a GPS antenna in the one-to-many manner, a separate GPS distributor must be used and each customer base transceiver station must still have the GPS receiver module. Therefore, there is a problem in that this results in a high equipment cost.

The following patents each discloses features in common with the present invention but do not teach or suggest the inventive features specifically recited in the present application: U.S. Pat. No. 6,243,372 to Petch et al., entitled METHODS AND APPARATUS FOR SYNCHRONIZATION IN A WIRELESS NETWORK, issued on Jun. 5, 2001; U.S. Pat. No. 6,452,541 to Zhao et al., entitled TIME SYNCHRONIZATION OF A SATELLITE POSITIONING SYSTEM ENABLED MOBILE RECEIVER AND BASE STATION, issued on Sep. 17, 2002; U.S. Pat. No. 6,377,517 to Tursich, entitled METHOD AND SYSTEM FOR SYNCHRONIZING A TIME OF DAY CLOCK BASED ON A STELLITE SIGNAL AND A COMMUNICATION SIGNAL, issued on Apr. 23, 2002; U.S. Pat. No. 6,344,821 to Norimatsu, entitled MOBILE COMMUNICATION SYSTEM AND INTER-BASES STATION SYNCHRONIZING METHOD, issued on Feb. 5, 2002; U.S. Pat. No. 6,674,730 to Moerder, entitled METHOD OF AND APPARATUS FOR TIME SYNCHRONIZATION IN A COMMUNICATION SYSTEM, issued on Jan. 6, 2004; U.S. Pat. No. 6,671,291 to Soliman, entitled METHOD AND APPARATUS FOR SEQUENTIALLY SYNCHRONIZED NETWORK, issued on Dec. 30, 2003; U.S. Pat. No. 6,665,541 to Kransner et al., entitled METHODS AND APPARAT USES FOR USING MOBILE GPS RECEIVERS TO SYNCHRONIZE BASE STATIONS IN CELLULAR NETWORKS, issued on Dec. 16, 2003; U.S. Pat. No. 6,647,246 to Lu, entitled APPARATUS AND METHOD OF SYNCHRONIZATION USING DELAY MEASUREMENTS, issued on Nov. 11, 2003; U.S. Pat. No. 6,628,628 to Yamazaki, entitled WIRELESS COMMUNICATION HAVING OPERATION TIME CORRECTING FUNCTION, issued on Sep. 30, 2003; U.S. Pat. No. 6,621,813 to Petch et al., entitled METHODS AND APPARATUS FOR SYNCHRONIZATION IN A WIRELESS NETWORK, issued on Sep. 16, 2003; U.S. patent application No. 2004/0047307 to Yoon et al., entitled APPARATUS AND METHOD OF FLYWHEEL TIME-OF-DAY (TOD) SYNCHRONIZATION, published on Mar. 11, 2004; U.S. patent application No. 2004/0028162 to Skahan, entitled MOBILE NETWORK TIME DISTRIBUTION, published on Feb. 12, 2004; U.S. patent application No. 2003/0214936 to Goff, entitled USING GPS SIGNALS TO SYNCHRONIZE STATIONARY MULTIPLE MASTER NETWORKS, published on Nov. 20, 2003; U.S. patent application No. 2003/0139898 to Mileretal., entitled METHOD FOR SYNCHRONIZING OPERATION ACROSS DEVICES, published on Jul. 24, 2003; U.S. patent application No. 2003/0109264 to Syjrarinne etal., entitled METHOD, APPARATUS AND SYSTEM FOR SYNCHRONIZING A CELLULAR COMMUNICATION SYSTEM TO GPS TIME, published on Jun. 12, 2003; U.S. patent application No. 2003/0058742 to Pikula et al., entitled WIRELESS SYNCHRONOUS TIME SYSTEM, published on Mar. 27, 2003; U.S. patent application No. 2002/0186716 to Eidson, entitled SYNCHRONIZING CLOCKS ACROSS SUB-NETS, published on Dec. 12, 2002; U.S. patent application No. 2002/0167934 to Carter et al., entitled METHOD AND SYSTEM FOR TIMEBASE SYNCHRONIZATION, published on Nov. 14, 2002; and U.S. patent application No. 2002/0001299 to Petch et al., entitled METHODS AND APPARATUS FOR SYNCHRONIZATION IN A WIRELESS NETWORK, published on Jan. 3, 2002.

### SUMMARY OF THE INVENTION

Therefore, the present invention has been made in view of the above problem, and it is an object of the present invention to provide a system and method of synchronizing a satellite clock in a base transceiver station wherein, in a private wireless exchange system in an office environment having a number of base transceiver stations, a GPS receiver module is installed in one base transceiver station and clock modules are installed in the remaining base transceiver stations. The GPS receiver module of the one base transceiver station receives a GPS signal through a GPS antenna and sends the GPS signal to the remaining base transceiver stations, so that the remaining base transceiver stations can operate with an inexpensive clock module.

In accordance with an aspect of the present invention, there is provided a system of synchronizing a satellite clock between at least two base transceiver stations, the system comprising: a GPS receiver module adapted to extract clock information and time of date(TOD) information from a received GPS signal, to generate a first clock signal and first TOD data, and to output the first clock signal and first TOD data to a first base transceiver station and a base transceiver station of a next stage, the GPS receiver module being arranged within the first base-station transceiver; and a clock module adapted to generate a second clock signal and second TOD data synchronized with the first clock signal and first TOD data by performing a delay correction with one of the GPS receiver module of the first base transceiver station or the base transceiver station of a previous stage, and to output the second clock signal and second TOD data to its base transceiver station and a base transceiver station of the next stage upon the clock module receiving a first clock signal and first TOD data from one of the GPS receiver module of the first base transceiver station or the base transceiver station of the previous stage, the clock module being arranged within a base transceiver station other than the first base transceiver station.

In accordance with another aspect of the present invention, there is provided a base station system having a synchronized satellite clock, comprising: a main base transceiver station having a GPS receiver module adapted to extract clock information and TOD information from a received GPS signal and to generate a clock signal and TOD data for operating its base transceiver station; and at least one sub-base transceiver station, each at least one sub-base transceiver station having a clock module adapted to receive a clock signal and TOD data from one of the GPS receiver module of the main base transceiver station or an adjacent base transceiver station through a daisy chain, and to generate a clock signal and TOD data synchronized with the clock signal and the TOD data of the main base transceiver station by performing a delay correction with one of the GPS receiver module which has transmitted the clock signal and the TOD data or the adjacent base transceiver station.

In accordance with yet another aspect of the present invention, there is provided a method for synchronizing a satellite clock between at least two base transceiver stations forming a base station system, the method comprising: extracting clock information and TOD information from a received GPS signal with a first base transceiver station having a GPS receiver module; outputting a clock signal and TOD data used for operating the first base transceiver station from the extracted clock information and TOD information from the first base transceiver station; receiving clock signals and TOD data from one of the first base transceiver station or a base transceiver station of the previous stage through a daisy chain with a base transceiver station other than the first base transceiver station; measuring and correcting delays of the received clock signals and TOD data with a base transceiver station other than the first base transceiver station; and generating clock signals and TOD data synchronized with the clock signal and the TOD data of the first base transceiver station by correcting the received clock signals and TOD data in accordance with a value of the delay correction, and outputting the synchronized clock signals and TOD data to its base transceiver station and the base transceiver station of the next stage with a base transceiver station other than the first base transceiver station.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view showing a construction of a customer base station system employing a system for synchronizing a satellite clock in base transceiver station in accordance with an embodiment of the present invention;

FIG. 2 is a view showing a detailed construction block diagram of the GPS receiver module shown in FIG. 1; and

FIG. 3 is a view showing a detailed construction block of a clock module shown in FIG. 1.

### DETAILED DESCRIPTION

Now, exemplary embodiments of the present invention will be described in detail with reference to the annexed drawings in order that those skilled in the art can embody the present invention with ease.

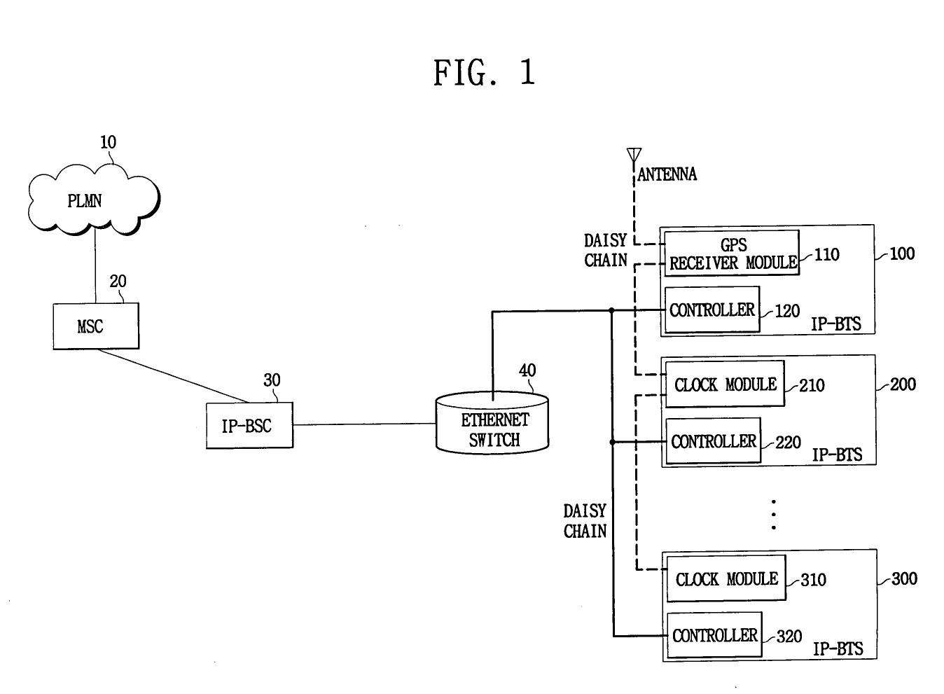

FIG. 1 is a view showing a construction of a customer base station system employing a system for synchronizing a satellite clock in base transceiver station in accordance with an embodiment of the present invention.

Referring to FIG. 1, a number of base transceiver stations 100, 200 and 300 are connected with one another through daisy chains. Each of the base transceiver station 100, 200 and 300 is connected to an Internet Protocol-Base Station Controller 30 (referred to as an IP-BSC, hereinafter) through an Ethernet switch 40, and the IP-BSC 30 is connected to a Public Land Mobile Network 10 (PLMN) through a Mobile Switching Center 20 (referred to as an MSC, hereinafter).

The base transceiver stations 100, 200 and 300 operate with the IP-BSC 30 to provide a wireless mobile communication service. FIG. 1 schematically shows that controllers 120,220 and 320 in the base transceiver stations 100, 200 and 300 control the wireless mobile communication service. The description of the function of the controllers 120, 220 and 320 has been abbreviated.

Here, the description is restricted to the fact that the satellite clock is synchronized in each of the base transceiver stations 100, 200 and 300 according to the GPS signal, and the description of technical matters performed in the base transceiver stations has been abbreviated.

As shown in FIG. 1, a number of the base transceiver stations 100, 200 and 300 can be divided into two types, that is, a base transceiver station 100 (referred to as a main base transceiver station, hereinafter) which receives a GPS signal through a GPS antenna and extracts a clock signal and Time Of Day (referred to as a TOD, hereinafter) necessary for operating its own base transceiver station from the GPS signal, and base transceiver stations 200 and 300 (referred to as sub-base transceiver station, hereinafter) which receive the clock signal and the TOD data from the main base transceiver station 100, perform a delay correction to be used therein and provide a base transceiver station of the next stage with the clock signal and the TOD data.

The main base transceiver station 100 has a GPS receiver module 110 receiving the GPS signal through the GPS antenna and processing it, and the sub-base transceiver stations 200 and 300 respectively have clock modules 210 and 310.

The GPS receiver module 110 installed in the mainbase transceiver station 100 extracts clock information and TOD information from the GPS signal received through the GPS antenna, generates the generated clock signal and TOD data for operating its own base transceiver station 100 and outputs the clock signal and the TOD data to its base transceiver station 100 and thebase transceiver station 200 of the next stage.

The clock module 210 installed in the sub-base transceiver station 200 receives a clock signal and TOD data from the GPS receiver module 110 of the main base transceiver station through the daisy chain. The clock module 210 generates a clock signal and TOD data which are synchronized with the clock signal and the TOD data used in the main base transceiver station 100 by performing a delay correction with the GPS receiver module 110 of the main base transceiver station 100, and outputs the clock signal and the TOD data to its own base transceiver station 200 and abase transceiver station of the next stage.

The clock module 310 installed in the sub-base transceiver station 300 receives the clock signal and TOD data from a clock module (not shown) of a base transceiver station of the previous stage through the daisy chain. The clock module 310 then generates a clock signal and TOD data synchronized with the clock signal and the TOD data used in the main base transceiver station 100 by performing a delay correction with the clock module (not shown) of the base transceiver station of the previous stage, and outputs the clock signal and the TOD data to its own base transceiver station 300.

In order to measure a delay of a clock received from the GPS receiver module 110 of the main base transceiver station 100 or a base transceiver station of the previous stage (not shown), the clock modules 210 and 310 transmit delay correction signals to the GPS receiver module 110 of the main base transceiver station 100 or a base transceiver station (not shown) of the previous stage, and measure and correct delays using the returned signals.

The delay must be corrected since a delay which occurs in a wireless communication system causes a phase synchronization difference so that a handoff may not be performed when the wireless terminal moves to another base station. Accordingly, the clock must be corrected in order to guarantee a stable handoff.

The operation of synchronizing a GPS satellite clock in the above system is described below.

The GPS antenna receives the GPS signal from a satellite and sends it to the main base transceiver station 100 using a cable. The GPS receiver module 110 in the main base transceiver station 100 extracts a clock signal and TOD data indicating time information from the GPS signal received in the GPS antenna.

The extracted clock signal and TOD data are used in its own base transceiver station 100 and also transmitted to the next base transceiver station 200. The main base transceiver station 100 sends back a delay correction signal to the next base transceiver station 200 in order to correct the delay which occurred during the clock transmission.

On the other hand, each of clock modules 210 and 310 in the sub-base transceiver stations 200 and 300 receives the clock signal and the TOD data sent by the GPS receiver module 110 and generates clocks to be used in their base transceiver stations 200 and 300. In order to measure the delay of the clocks sent by the GPS receiver module 110 or the clock module of the base transceiver stations 200 and 300, each of the clock modules 210 and 310 sends a delay correction signal to the base transceiver station of the previous stage and performs a measurement and correction of the delay using a returned signal so that the clock signal to be used in its base transceiver station is corrected.

Also, the base transceiver stations send the clock signal and the TOD data to the next base transceiver station so that the next base transceiver station can use the signal and the data. Then, since the clock module of the next base transceiver station also needs to perform the delay correction, it performs a function of returning the delay correction signal.

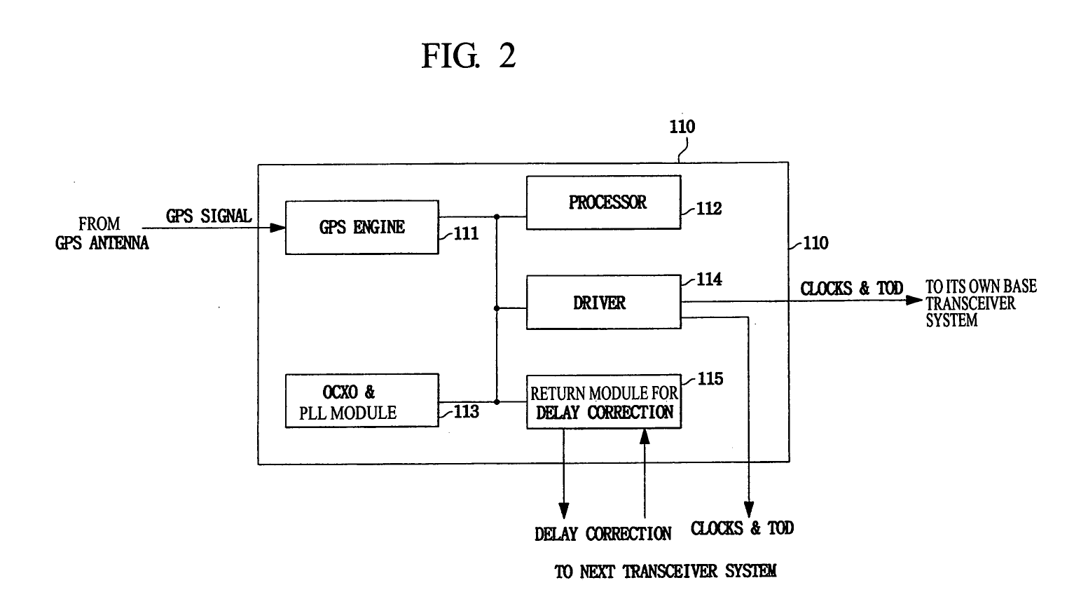

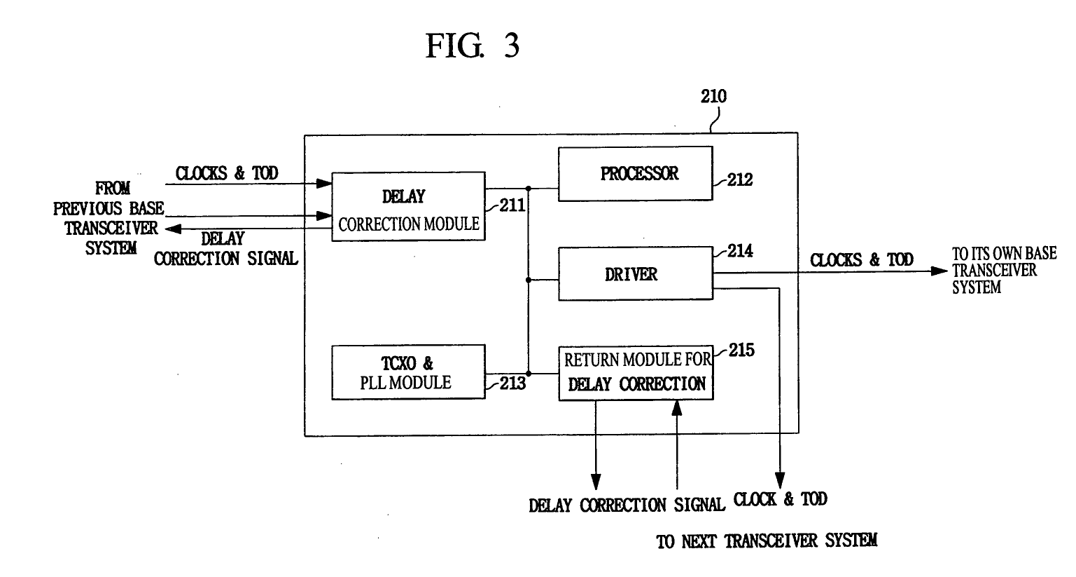

The details of a GPS receiver module and a clock module are described with reference to FIGS. 2 and 3.

FIG. 2 is a view showing a detailed block diagram of the GPS receiver module shown in FIG. 1. Referring to FIG. 2, the GPS receiver module 110 includes a GPS engine 111, a processor 112, a Phase Locked Loop module 113 (referred to as a PLL module, hereinafter), a driver 114 and a return module for delay correction 115.

The GPS engine 111 performs a function of extracting clock information and TOD information from the GPS signal received by a GPS antenna.

The PLL logic 113 generates a clock signal and TOD data in accordance with the clock information and the TOD information extracted by the GPS engine 111.

The PLL module 113 is generally called a frequency synthesizer. The PLL module 113 forms a phase control loop, which continuously provides a phase of output signal coinciding with a phase of an input signal.

Referring to FIG. 2, an Oven-controlled Oscillator (referred to as an OCXO, hereinafter) is shown together with the PLL module. The OCXO provides the entire system with a timing source. That is, the OCXO makes reverse use of the property that a crystal is heat sensitive and it constantly maintains the temperature around the crystal using an oven so as not to cause any clock error. Even though the OCXD has the best precision among crystal application products, it has a large size and uses various power sources such as 12V, 24V and 30V compared to other products using 3.3V or 5V so that it is generally used for a repeater or satellite communication equipment rather than personal hand-held communication equipment.

The driver 114 outputs the clock signal and the TOD data generated by the PLL module 113 to its own base transceiver station 100 and the base transceiver station 200 of the next stage.

The return module for delay correction 115 performs a function of sending back the delay 11 correction signal received from the clock module 210 of the next base transceiver station 200 in order to perform the delay correction of the next base transceiver station 200.

The processor 112 extracts the clock information and the TOD information with the help of the GPS engine 111 in case of receiving the GPS signal from the GPS antenna, generates a clock signal and TOD data with the help of the PLL module 113, outputs the clock signal and TOD to its own base transceiver station 100 and the next base transceiver station 200 through the driver 114, and processes a delay correction request sent from the base transceiver station 200 of the next stage with the help of the return module for delay correction 115.

An operation to perform a synchronization of the GPS satellite clock in the GPS receiver module 110 constructed as described above is explained below.

On receiving the GPS signal from the GPS antenna, the GPS engine 111 extracts clock information and TOD information from the received GPS signal.

The TOD data includes information on header and system time, state information, alarm information and leap second check sum.

When clock information and the TOD information are extracted by the GPS engine 111, the processor 112 controls the PLL module 113 to generate the clock and the TOD data to be used in its own base transceiver station 100. The PLL module 113 receives the clock information and the TOD information extracted by the GPS engine 111, and generates a clock signal and TOD data needed for the system in accordance with a specification already established by the processor 112. For example, clock signals such as 10 MHz, Pulse Per 2 Second (PPP2S) and 19.6608 MHz are generated.

Then, the driver 114 outputs the generated clock signal and TOD data to its own base transceiver station 100 and the clock module 210 of the base transceiver station 200 of the next stage.

On the other hand, the clock module 210 of the base transceiver station 200 of the next stage sends a delay correction signal to correct a delay of the received clock signal to the GPS receiver module 110. In such a case, the return module for delay correction 115 sends back to the sender the delay correction signal transmitted from the clock module of the base transceiver station of the next stage as is.

The base transceiver station of the next stage corrects the delay of the clock received from the main base transceiver station using the signal returned from the return logic for delay correction 115, and then generates a clock signal synchronized with the clock signal used in the main base transceiver station and provides its base transceiver station with the synchronized signal.

FIG. 3 is a view showing a detailed block of the clock module shown in FIG. 1.

Referring to FIG. 3, the clock module 210 includes a delay correction module 211 which measures a delay of the clock received from a main base transceiver station 100 and corrects the delay, a processor 212 for controlling the clock module 210, a PLL module 213 for synchronizing using a clock from the GPS receiver module 110, a driver 214 for sending out a clock and TOD, and a return module for delay correction 215 for sending back a delay correction signal sent by the next base transceiver station (not shown) in order to perform a delay correction of the next base-station transceiver.

The delay correction module 211 receives the clock signal and the TOD data from the main base transceiver station 100, and measures and corrects the delay of the received clock.

The PLL module 213 receives the clock signal and the TOD data and a delay correction value received from the delay correction module 211, and generates a clock signal and TOD data which reflects the delay correction.

Referring to FIG. 3, a Temperature Compensated Crystal Oscillator (referred to as a TCXO, hereinafter) is shown together with the PLL module. The TCXO is a device outputting a very stable reference signal having a few to tens of MHz among constituents of a mobile communication terminal, which is embodied by an oscillating circuit controlling the oscillating frequency using the crystal oscillator. In order to perform a frequency temperature stabilization which is an important property in the TCXO, the ambient temperature must be in the range of −30˜85° C. and a frequency stability of a carrier required in the temperature is ±2.5 ppm and the room temperature deviation is established in ±0.2 ppm.

On reviewing recent developments of TCXOs from an aspect of the temperature compensation scheme, a development of a D-TCXO to compensate the temperature using a digital circuit is in progress wherein a component or a circuitry whose reactance is changeable by external data is inserted into an oscillation loop of the crystal oscillation circuit so that the necessary temperature compensation can be obtained. From an aspect of miniaturization, a development of a D-TCXO is in progress wherein the crystal oscillator is embodied in a form of SMD and is covered in a form of a case on a board on which the basic circuit of the TCXO is mounted so that the area of the crystal oscillator is reduced.

The driver 214 outputs the clock signal and the TOD data generated in the PLL module 213 to its base transceiver station 200 and a base transceiver station (not shown) of the next stage.

The return module for delay correction 215 performs a function of sending back a delay correction signal received from the clock module of the next base transceiver station (not shown) in order to perform the delay correction of the next base transceiver station (not shown).

The processor 210 performs the delay correction of the clock signal and the TOD data received from the main base transceiver station 100 by the delay correction module 211 and the PLL module 213, outputs the corrected data to its base transceiver station 200 and the base transceiver station of the next stage (not shown) through the driver 214, and controls each constituent to make the return module of delay correction 215 process a delay correction request sent by the base transceiver station of the next stage (not shown).

Now, an operation for synchronizing GPS satellite clock in the clock module 210 constructed as described above will be explained.

On receiving the clock signal and the TOD data from the previous base-station transceiver, that is, the GPS receiver module 110 of the main base transceiver station 100, the delay correction module 211 transmits the delay correction signal to the GPS receiver module 110 of the main base transceiver station 100 in order to measure the delay of the received clock. More concretely, the delay correction signal is transmitted to the return module for delay correction 115. And, the measurement and correction of the delay is performed using the returned signal from the return module for delay correction 115.

When the delay correction module 211 outputs the clock signal and the TOD data received from the GPS receiver module 110 of the main base transceiver station 100 and accordingly the correction control signal, the PLL module 213 corrects the clock signal and the TOD data received from the delay correction module 211 according to the correction control signal and generates a clock signal and TOD data synchronized with the clock signal and the TOD data used in the main base transceiver station 100. Of course, the PLL module 213 generates a clock signal and TOD data required in the system in accordance with the specification established by the processor 212.

Then, the driver 214 outputs the generated clock signal and TOD data to its base transceiver station 200 and then outputs them to a clock module of a base transceiver station of the next stage.

On the other hand, a clock module (not shown) of the base transceiver station (not shown) of the next stage transmits to the clock module 210 a delay correction signal to correct the received clock signal. In such a case, the return module for delay correction 215 sends back the delay correction signal transmitted from the clock module of the base transceiver station of the next stage as it is.

The base transceiver station of the next stage corrects the delay of the clock received from the base transceiver station 200 using the signal returned from the return module for delay correction 215, and accordingly and finally generates a clock signal synchronized with the clock signal used in the main base transceiver station and then provides its own base transceiver station with the clock signal.

As described above, when the main base transceiver station 100 has one GPS receiver module 110 and the remaining base transceiver stations 200 and 300 have cheap clock modules 210 and 310, it is possible to construct the customer wireless exchange system by connecting a number of base transceiver stations with one another.

In a conventional customer wireless communication exchange system, each customer base transceiver station should be directly connected to a GPS antenna in a one-to-one manner, or many customer base transceiver stations should be connected to one GPS antenna in the one-to-many manner using a GPS distributor. At that time, each customer base transceiver station should have a GPS receiver module.

In accordance with the present invention, however, since every customer base transceiver station can make use of a GPS signal with one GPS antenna, it does not need to install more than one GPS antenna and cables for that.

Also, a system in accordance with the present invention is profitable economically since it is possible that the GPS receiver module having an expensive OCXO and a GPS engine is used only in one customer base transceiver station and remaining customer base transceiver stations use cheap clock modules.

Also, a delay occurring due to the fact the customer base transceiver stations are connected with one another using a Daisy chain can be solved with a delay correction module, so that every customer base transceiver station can have the same clock phase as the nearest customer base transceiver station to the GPS antenna and a stable handoff can be performed between wireless base stations.

What is claimed is:

1. A system comprising:
a GPS receiver module adapted to extract clock information and time of date(TOD) information from a received GPS signal, to generate a first clock signal and first TOD data, and to output the first clock signal and first TOD data to a first base transceiver station and a base transceiver station of a next stage, the GPS receiver module being arranged within the first base-station transceiver; and
a clock module adapted to generate a second clock signal and second TOD data synchronized with the first clock signal and first TOD data by performing a delay correction with one of the GPS receiver module of the first base transceiver station or a base transceiver station of a previous stage, and to output the second clock signal and second TOD data to its base transceiver station and a base transceiver station of the next stage upon the clock module receiving a first clock signal and first TOD data from one of the GPS receiver module of the first base transceiver station or the base transceiver station of the previous stage, the clock module being arranged within a base transceiver station other than the first base-station transceiver.

2. The system according to claim 1, wherein the GPS receiver module comprises:
a GPS engine adapted to extract the clock information and TOD information from the received GPS signal;
a PLL module adapted to generate the first clock signal and first TOD data according to the extracted clock information and TOD information;
a driver adapted to output the first clock signal and first TOD data to the first base transceiver station and the base transceiver station of the next stage;
a return module adapted to effect delay correction by returning a delay correction signal received from a clock module of the base transceiver station of the next stage; and
a processor adapted to control extracting clock information and TOD information with the GPS engine, to control generating a first clock signal and first TOD data with the PLL module, to control outputting the first clock signal and first TOD data to its base transceiver station and the base transceiver station of the next stage, and to control processing a delay correction request received from the base transceiver station of the next stage with the return module, upon the processor receiving the GPS signal from the GPS antenna.

3. The system according to claim 1, wherein the clock module comprises:
a delay correction module adapted to receive the clock signal and the TOD data from one of the first base transceiver station or the base transceiver station of the previous stage, to measure a delay of the received clock, and to generate a delay correction value;
a PLL module adapted to receive the clock signal and the TOD data received in the delay correction module and the delay correction value and to generate a second clock signal and second TOD data corrected in accordance with the delay correction value;
a driver adapted to output the second clock signal and second TOD data to its base transceiver station and the base transceiver station of the next stage;
a return module adapted to effect delay correction by returning the delay correction signal received from a clock module of the base transceiver station of the next stage; and
a processor adapted to control performing a delay correction of the clock signal and the TOD data received from one of the first base transceiver station or the base transceiver station of the previous stage with the delay correction module and the PLL module, to control outputting the second clock signal and second TOD data to its base transceiver station and the base transceiver station of the next stage using the driver, and to control processing of a delay correction request received from the base transceiver station of the next stage with the return module.

4. The system according to claim 1, wherein the delay correction module is adapted to measure the delay of the clock received in the GPS receiver module of one of the first base transceiver station or the base transceiver station of the previous stage by transmitting the delay correction signal to one of the GPS receiver module of the first base transceiver station or the base transceiver station of the previous stage, and to measure and correct the delay in accordance with a signal returned thereto.

5. A system comprising:
a main base transceiver station having a GPS receiver module adapted to extract clock information and TOD information from a received GPS signal and to generate a clock signal and TOD data used for operating its base-station transceiver; and
at least one sub-base transceiver station, each at least one sub-base transceiver station having a clock module adapted to receive a clock signal and TOD data from one of the GPS receiver module of the main base transceiver station or an adjacent base transceiver station through a daisy chain, and to generate a clock signal and TOD data synchronized with the clock signal and the TOD data used in the main base transceiver station by performing a delay correction with one of the GPS receiver module which has transmitted the clock signal and the TOD data or the adjacent base-station transceiver.

6. A method comprising:
extracting clock information and TOD information from a received GPS signal, with a first base transceiver station having a GPS receiver module;
outputting a clock signal and TOD data used for operating the first base transceiver station from the extracted clock information and TOD information from the first base-station transceiver;
receiving clock signals and TOD data from one of the first base transceiver station or a base transceiver station of the previous stage through a daisy chain, with a base transceiver station other than the first base-station transceiver;
measuring and correcting delays of the received clock signals and TOD data with a base transceiver station other than the first base-station transceiver; and
generating clock signals and TOD data synchronized with the clock signal and the TOD data used in the first base transceiver station by reflecting a value of the delay correction to the received clock signals and TOD data, and outputting the synchronized clock signals and TOD data to its base transceiver station and the base transceiver station of the next stage, with a base transceiver station other than the first base-station transceiver.

7. The method according to claim 6, wherein measuring and correcting the delay includes transmitting the delay correction signal to one of the first base transceiver station or the base transceiver station of the previous stage, and measuring and correcting a delay using a signal being returned, in order to measure a clock delay received from one of the first base transceiver station or the base transceiver station of the previous stage.

8. A system comprising:
a first base transceiver station including a GPS receiver module adapted to extract clock information and time of date (TOD) information from a received GPS signal and to generate and output a clock signal and TOD data therefrom; and
another base transceiver station including a clock module, the clock module being coupled to the GPS receiver module of the first-base transceiver station and adapted to receive the clock signal and TOD data from the GPS receiver module and to generate another clock signal and another TOD data synchronized with the clock signal and TOD data from the GPS receiver module by performing a delay correction.

9. The system of claim 8, further comprising at least one other base transceiver station including another clock module, the another clock module being coupled to the clock module of the another base transceiver station and adapted to receive the clock signal and TOT data from the another clock module and to generate an additional clock signal and an additional TOD data synchronized with the clock signal and TOD data from the another clock module by performing a delay correction.
